(19) United States
(12) Patent Application Publication
(10) Pub. No.: US 2009/0114256 A1
(43) Pub. Date: May 7, 2009

(54) Ostomy bag cleaning device

(76) Inventors: Bobby Bailiff, Stamford, TX (US); Larry Bailiff, Stamford, TX (US)

Correspondence Address: DELPHINE M. JAMES, 2656 SOUTH LOOP WEST #170, HOUSTON, TX, 77054, US

(21) Appl. No.: 11/975,156

(22) Filed: Oct. 17, 2007

Related U.S. Application Data
(63) Continuation of application No. 10/897,391, filed on Apr. 21, 2004, now abandoned.

(51) Int. Cl. B08B 3/10

(52) U.S. Cl. 134/57 R; 134/56 R

(57) ABSTRACT

An ostomy cleaning device comprises a relatively small tank having a heating element, an inlet port and an outlet port. The inlet port is coupled to a water supply and the outlet port coupled to a hose attachment. A sprayer nozzle attached to the hose attachment. A pressure regulator is operationally coupled between the water supply and the inlet port for controlling the water pressure from the water supply to a level sufficient to accommodate the hose attachment. A temperature regulator is operationally coupled to the heating element for controlling the temperature of the water contained in the tank to a relatively warm temperature.

### NON-PROVISIONAL PATENT APPLICATION

This application is a continuation of Ser. No. 10/897,391

### BACKGROUND

The present invention relates to a device for cleaning a ostomy bag worn by an ostomy patient. After a patient has an ostomy operation in which a portion of the intestinal is removed, the body waste is excreted into an attached ostomy bag. When the ostomy bag becomes full, the bag must be cleaned. Since the bag contains human waste, the ostomy bag must be cleaned in a sanitary manner. It is the object of the present invention to provide an apparatus for efficiently cleaning the ostomy bag an discarding the human waste into a sewage facility

### SUMMARY

The present invention provides a device adapted to clean an ostomy bag. The device comprises a relatively small tank having a heating element, an inlet port and an outlet port. The inlet port is coupled to a water supply and the outlet port coupled to a hose attachment. A sprayer nozzle attached to the hose attachment. A pressure regulator is operationally coupled between the water supply and the inlet port for controlling the water pressure from the water supply to a level sufficient to accommodate the hose attachment. A thermostat is operationally coupled to the heating element for controlling the temperature of the water contained in the tank to a relatively warm temperature.

### BRIEF DESCRIPTION OF DRAWINGS

Various other features of the present invention will be better understood when considered in conjunction with the accompanying drawings.

FIG. 1 illustrates a perspective view of the present invention.

FIG. 2 illustrates an exploded view of the heating unit.

FIG. 3 illustrates an exploded external view of the heating unit with the nozzle attachments.

FIG. 4 illustrates an alternative embodiment perspective view of the present invention utilizing a mixing valve.

FIG. 5 illustrates an exploded view of the alternative embodiment.

FIG. 6 illustrates an exploded view of Mixing Valve

FIG. 7 illustrates an exploded view of the pressure regulator

### DETAILED SPECIFICATION

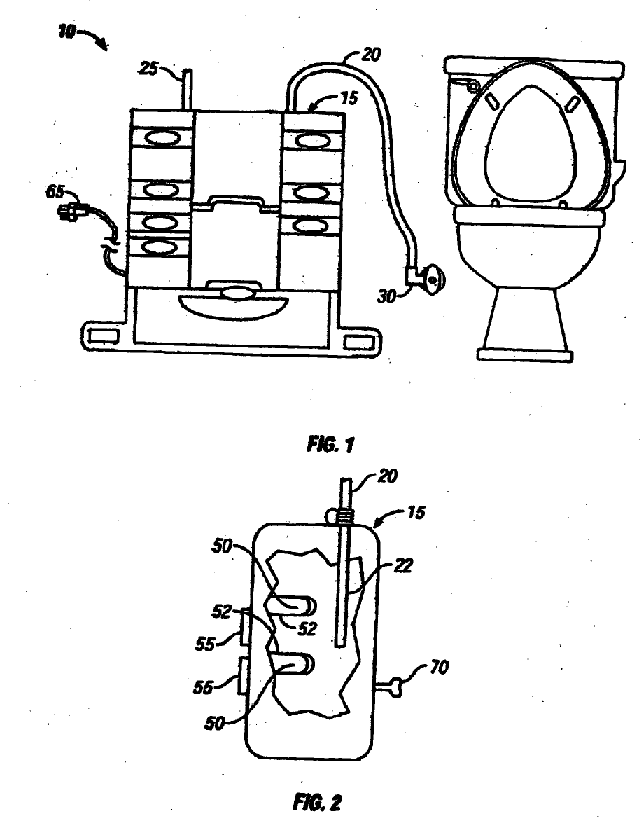

Referring to FIG. 1, there is shown a perspective view of the present invention, a device (10) for cleaning an ostomy bag. Device (10) further comprises a relatively small tank (15) having an inlet port (20) and an outlet port (25). Inlet port (20) is operationally coupled to the house water supply (30) for providing cold water into the tank (15). Generally, device (10) is coupled to the water supply near a toilet. Using device (10) near a toilet allows for sanitary disposal of bodily waste.

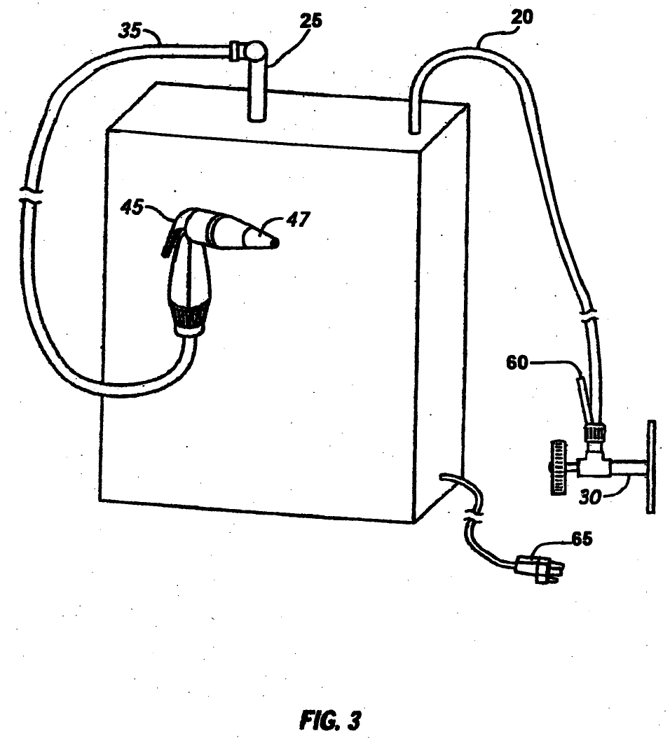

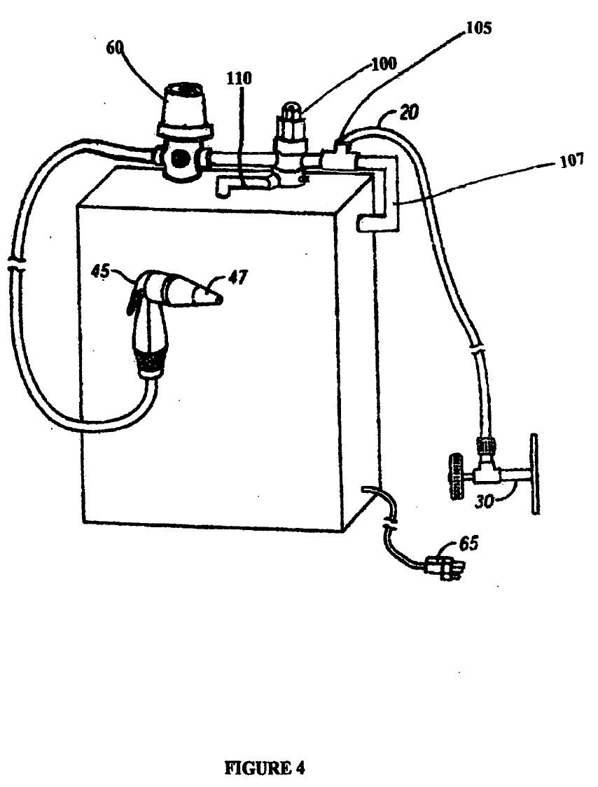

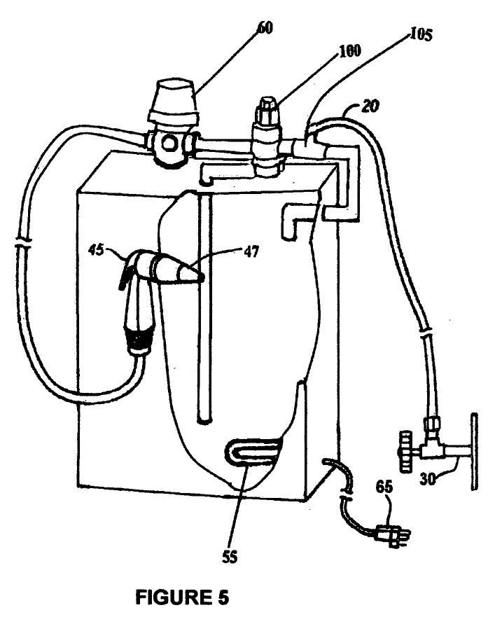

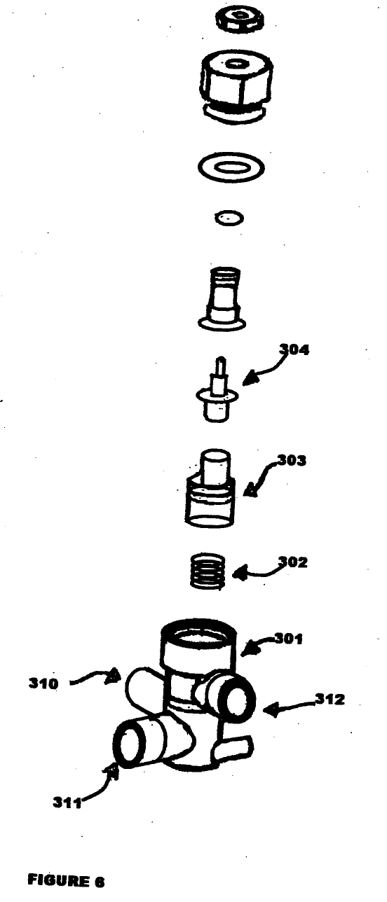

Referring to FIG. 2, there is shown an exploded cross-sectional view of the tank (15). Tank (15) can be a small conventional portable water heater capable of holding at least one gallon of water. Inlet port (20) can be conventional piping with a mechanism for pumping the cold water in tank (15). Inlet port (20) can be coupled to an elongated pipe (22) which extends near the bottom of the tank. Elongated pipe (22) can be a conventional dip tube utilized in water heaters. As cold water is drawn into the bottom of the tank (15), it remains at the bottom because the cold water is denser than hot water. At the lower end of tank (15) is a drain outlet pipe (70) for draining tank (15).

Operationally situated within tank (15) is a heating element (50) for heating the cold water in the tank (15). Heating element (50) can be conventional electric heating coils. The electric coils are immersed in the water of the tank. The tank can have more than one heating element. In some heaters, the heating element can be a gas burner.

Temperature regulator (55) is operationally associated with heating element (50). Temperature regulator (55) can be a conventional thermostat. Thermostat (55) can be operationally installed within the internal wall of the tank. Also, thermostat (55) can be surrounded by insulation material to prevent operational interference by the water within the tank (15). Thermostat (55) controls the temperature of the water in tank (15). When the temperature of the water in tank (15) reaches the set temperature, a heat anticipator automatically shuts heating element (50). When the temperature of the water decreases below the required temperature, a control switch mechanism automatically turns the heating element (50) back on. Each heating element can be associated with a separate thermostat. Additionally, the set temperature of the water in the tank can be adjustable via knob (52).

To prevent injury, the water cannot be scalding hot as conventional water heaters. However, the water must be at a relatively warm temperature for sanitation purposes. A relatively warm temperature of the water in tank (15) can be between 84 and 100 degrees. Thus, thermostat (55) of the present invention is specifically designed not to exceed the required water temperature of tank (15). A conventional portable water heater currently maintains the water temperature between (120 and 140 degrees) which is too hot for the present invention.

As shown in FIG. 3, pressure regulator (60) is operationally coupled between the water supply (30) and the inlet port (20) for controlling the water pressure from the water supply to a level sufficient to accommodate the hose attachment (35). The PSI for a home is normally approximately 50-60 PSI, which is too powerful for the hose attachment (35). Thus, a pressure regulator (60) is required to maintain the pressure at a certain level. The PSI for the hose attachment is generally between 1 and 5 lbs.

Power source (65) is connected to tank (15). Power source (65) can be electrical or battery powered for portability. Some water heaters can be powered by gas. Power source (65) is required for heating element (50) illustrated in FIG. 2. mixing valve 100 is set to a predetermined safety range upon installation. For example, currently a conventional mixing valve can be utilized to implement this invention or another mechanism capable of controlling water temperature at a constant temperature. Mixing valve mechanism 100 controls the temperature of the output of water into pressure regulator 60 by controlling the proportions of cold water from the household water supply 30 and of hot water from the hot water heater 15 necessary to maintain the constant temperature of the output of the water to the pressure regulator 60. In operation, the mixing valve mechanism 100 is set to a temperature between 95-99 degrees which is done generally upon installation and the pressure regulator 60 is set between 1-5 lbs of pressure. In this embodiment as depicted the pressure regulator 60 is disposed between the mixing valve 100 and the hose connection to the nozzle sprayer 47 thereby providing a constant pressure of water at a constant temperature to the nozzle sprayer 47.

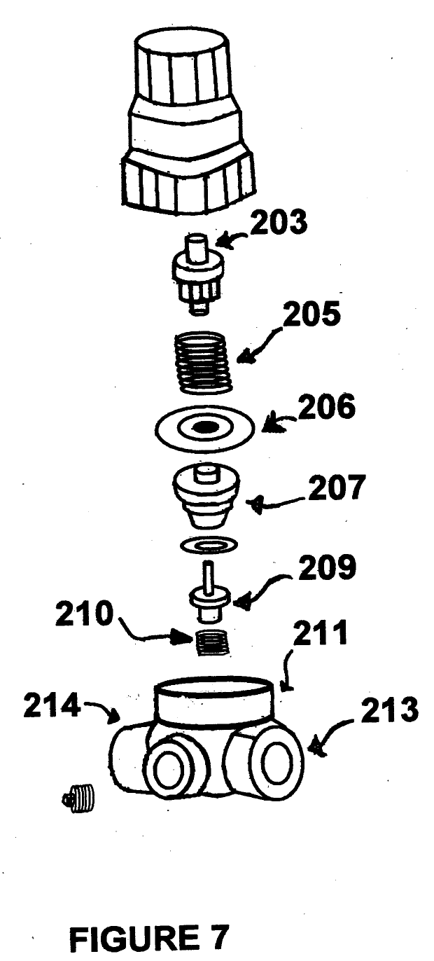

FIGS. 6 and 7 respectively illustrate of commercially available mixing valve and pressure regulator used in the market place today. The two above mentioned devices are separate devices that are combined and incorporated into this invention in a novel arrangement. Referring to FIG. 6, in this embodiment of the present invention hot water is fed into the mixing valve through inlet 311 and then flows through a tubular opening in the center of piston 303 which is arranged in the center of valve body 301 and is springingly mounted in the axial direction. The termination of the valve body 301 forms the abutment for the spring 302. The end of the piston 303 remote from inlet 311 is mounted so that it abuts thermostat 304. The hot water from inlet 311 flows into the center of piston 303 where it is mixed with cold water from inlet 310, after which the mixture flows around a wax-filled temperature responsive thermostat 304 before it flows out through outlet 312. The thermostat 304 expands and contracts in relation to the water temperature and communicates through piston 304 to alter the balance of flow through inlets 310 and 311 to maintain a constant water temperature of discharge through outlet 312.

Referring to FIG. 7, in this embodiment of the present invention temperature controlled water under pressure flows through inlet 213 and enters the working chamber 211 of the pressure regulator. Diaphragm 206 is subject to the preset force exerted from spring 205, which can be set with adjustment screw 203 so that the desired pressure in outlet 214 and pressure exerted on diaphragm 206 are in a state of equilibrium. Pressure in working chamber 211 exerts an equal amount of force on inlet supply seat 207 and exhaust valve 209, exhaust valve spring 210 allows exhaust valve 209 to be maintained in an open position until the preset desired pressure at 214 is achieved.

What is claimed is:

1. A device for cleaning an ostomy bag that is directly connected to an opening in the abdomen of the body, the device comprising: a relatively small tank having an inlet port and an outlet port; the inlet port directly coupled to the house water supply line, the inlet port for providing cold water into the tank; the outlet port coupled to a hose attachment; at least one heating element operationally situated internally within the tank, the at least one heating element for heating the water contained within the tank; a pressure regulator operationally coupled to the water supply for automatically controlling the water pressure from the water supply to a predetermined water pressure level that prevents the displacement of the ostomy bag from the opening in the body, prevents the contamination of the opening in the body with the fecal contents of the ostomy bag; and is sufficient to accommodate the hose attachment; a temperature regulator operationally coupled to the at least one heating element for automatically maintaining the temperature of the water contained in the tank at a predetermined warm temperature level required to prevent damage the body area directly attached to the ostomy bag; a sprayer nozzle coupled to the hose attachment for irrigating the ostomy bag as well as the body with the warm water contained in the tank; and a power source operationally coupled to the tank.

2. The device of claim 1 wherein the power source is electrical.

3. The device of claim 1 wherein the power source is battery.

4. The device of claim 3 wherein the battery is rechargeable.

5. The device of claim 1 wherein the temperature regulator is adjustable.

6. The device of claim 1 wherein the temperature regulator further comprises: a heat anticipator operationally associated with to heat element such that the at least one heating element turns off when the water reaches the predetermined temperature; and a control switch mechanism operationally associated with the at least one heating element such that the at least one heating element turns on when the water in the tank reaches the predetermined temperature.

7. The device of claim 1 further comprising: the tank being defined by a top and a bottom; an elongated pipe internally situated within the tank extending from the top of the tank to near the bottom of the tank; and the pipe being coupled to the inlet port.

8. The device of claim 1 wherein the temperature regulator is digital.

9. The device of claim 1 further comprising a cone member attached to the sprayer nozzle.

10. The device of claim 9 wherein the cone member is detachable from the sprayer nozzle.

11. The device of claim 1 further comprising a drain outlet pipe attached to the lower end of the tank.

12. The device of claim 1 wherein the predetermined temperature is in a range between 84-94 degrees which is a temperature that does not injure the body area attached to the ostomy bag.

13. The device of claim 1 wherein the water pressure is between 1 and 5 lbs of pressure which is a pressure that does not injure the body area attached to the ostomy bag.

14. The device of claim 1 wherein the nozzle is tapered to fit into a small opening within the ostomy bag.

15. The device of claim 14 wherein the nozzle is adapted with a small opening to fit the predetermined water pressure.

16. A device for cleaning an ostomy bag, the device comprising:
a small portable heater in direct fluid communication with a household water supply line from the municipality, the heater adapted to receive cold water from the household water supply and heat the water to a predetermined temperature;
a mixing valve mechanism in direct fluid communication with the household water supply line and the portable heater, the mixing valve mechanism adapted to receive a proportionally amount of hot water from the heater and cold water from the household water supply, the mixing valve mechanism adapted to output water at a predetermined warm temperature level sufficient to prevent damage to the body area connected to the ostomy bag;
a pressure regulator in fluid communication with the mixing valve mechanism and disposed between the mixing valve mechanism and a hose attachment, the pressure regulator adapted to receive water from the mixing valve mechanism and to output water at a constant decreased predetermined pressure level necessary to prevent the displacement of the ostomy bag from the opening in the body and to prevent the contamination of the opening in the body with the fecal contents of the ostomy bag; and
a sprayer nozzle operationally coupled to the hose attachment for irrigating the ostomy bag as well as the body with the warm water contained in the tank; and
a power source operationally coupled to the tank.

17. A device for cleaning an ostomy bag that is directly connected to an opening in the abdomen of the body, the device comprising:
a relatively small tank having an inlet port and an outlet port;
the inlet port directly coupled to and in fluid communication with the house water supply line, the inlet port for providing cold water into the tank;
a mixing valve mechanism having a second inlet port and a third inlet port, and a second outlet port operationally coupled to a pressure regulator;
at least one heating element operationally situated internally within the tank, the at least one heating element for heating the water contained within the tank;
the second inlet port of the mixing valve mechanism in direct fluid communication with the house hold water supply for directly receiving cold water therefrom;
the third inlet port in direct fluid communication with the outlet port of the tank for directly receiving hot water therefrom wherein the mixing valve mechanism provides a means for automatically controlling at a constant predetermined warm temperature level required to prevent damage to the body area through the second outlet port;
the pressure regulator disposed between the mixing valve mechanism and a hose attachment, the pressure regulator in fluid communication with the second outlet port of the mixing valve mechanism wherein the pressure regulator automatically controls the water pressure from the second outlet port of the mixing valve mechanism to a predetermined decreased water pressure level thereby preventing displacement of the ostomy bag from the opening in the body and preventing the contamination of the opening in the body with the fecal contents of the ostomy bag; and
a sprayer nozzle operationally coupled to the hose attachment for irrigating the ostomy bag as well as the body with the warm water contained in the tank; and
a power source operationally coupled to the tank.
